(19) United States
(12) Patent Application Publication
(10) Pub. No.: US 2025/0286976 A1
(43) Pub. Date: Sep. 11, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Hisashi Hagiwara, Kanagawa (JP)

(73) Assignee: FUJIFILM Business Innovation Corp., Tokyo (JP)

(21) Appl. No.: 18/795,367

(22) Filed: Aug. 6, 2024

(30) Foreign Application Priority Data
Mar. 11, 2024 (JP) 2024-037109

(51) Int. Cl. H04N 1/60

(52) U.S. Cl. CPC H04N 1/60

(57) ABSTRACT

An information processing system includes a processor configured to, upon being instructed to form an image based on the same image data as a first image that was formed by a certain image forming apparatus, execute a mode to create first color adjustment data for another image forming apparatus on the basis of first read data obtained by reading the first image that was formed by the certain image forming apparatus, and cause the other image forming apparatus to form an image on the basis of the image data and the first color adjustment data.

### CROSS-REFERENCE TO RELATED APPLICATIONS

This application is based on and claims priority under 35 USC 119 from Japanese Patent Application No. 2024-037109 filed Mar. 11, 2024.

### BACKGROUND

### (i) Technical Field

The present disclosure relates to an information processing system, an information processing method, and a non-transitory computer readable medium.

### (ii) Related Art

The image forming apparatus described in Japanese Unexamined Patent Application Publication No. 2022-62512 is characterized by including: scanning means for scanning printed material; determining means for determining whether a certain area in image data obtained by scanning is an area printed in K monochrome or CMY mixed color on the printed material; and generating means for generating print parameters on the basis of the result determined by the determining means.

### SUMMARY

Aspects of non-limiting embodiments of the present disclosure relate to an information processing system in which, when an image based on the same image data as a first image formed by a certain image forming apparatus is formed by another image forming apparatus, the color tone of the image is brought closer to the color tone of the first image as compared to the case of using first color adjustment data for the certain image forming apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to, upon being instructed to form an image based on the same image data as a first image that was formed by a certain image forming apparatus, execute a mode to create first color adjustment data for another image forming apparatus on the basis of first read data obtained by reading the first image that was formed by the certain image forming apparatus, and cause the other image forming apparatus to form an image on the basis of the image data and the first color adjustment data.

### BRIEF DESCRIPTION OF THE DRAWINGS

Exemplary embodiments of the present disclosure will be described in detail based on the following figures, wherein:

FIG. 1 is an overview of an image forming system according to an exemplary embodiment of the technology of the present disclosure;

FIG. 2 is a block diagram illustrating a hardware configuration of an image forming system according to the exemplary embodiment;

FIG. 3 is a flowchart from the acceptance of a job to the end of the job in an information processing program according to the exemplary embodiment;

FIG. 4 is a sequence diagram for the case of backing up a job to be formed for the first time in an information processing program according to the exemplary embodiment;

FIG. 5 is a sequence diagram for the case in which a user selects a job to be re-formed and the image is to be formed by the same image forming apparatus as the first time in an information processing program according to the exemplary embodiment;

FIG. 6 is a sequence diagram for the case in which a user selects a job to be re-formed and the image is to be formed by a different image forming apparatus from the first time in an information processing program according to the exemplary embodiment;

FIG. 7 is a flowchart illustrating details of an inspecting step in an information processing program according to the exemplary embodiment;

FIG. 8 is a sequence diagram for the case of performing a color check with an inspection unit during re-formation in an information processing program according to the exemplary embodiment;

FIG. 9 is a sequence diagram for the case of backing up data to be re-formed during re-formation in an information processing program according to the exemplary embodiment;

FIG. 10 is a flowchart illustrating details of a retrieving step in an information processing program according to the exemplary embodiment;

FIG. 11 is a flowchart illustrating an example of determination of re-formation in an information processing program according to the exemplary embodiment; and

FIG. 12 is a sequence diagram for the case where a controller retrieves a job during re-formation in an information processing program according to the exemplary embodiment.

### DETAILED DESCRIPTION

Hereinafter, an exemplary embodiment of the technology of the present disclosure will be described with reference to the drawings. Note that in the drawings, identical or similar components and portions are denoted with the same reference signs.

### Configuration of Exemplary Embodiment

### Image Forming System

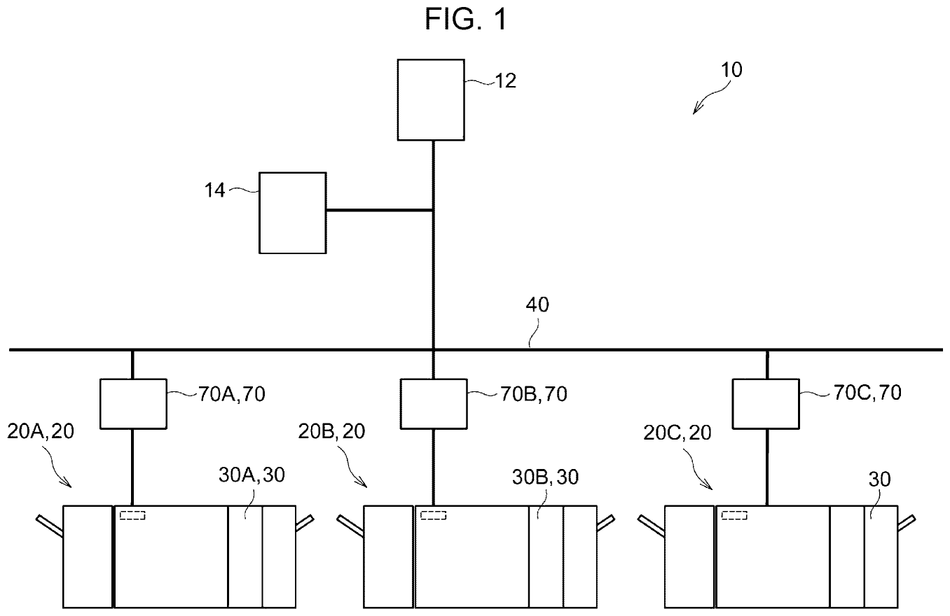

FIG. 1 is an overview of an image forming system 10 according to an exemplary embodiment of the technology of the present disclosure. The image forming system 10 is a system that forms, with any image forming apparatus, an image related to shared image data. The image forming system 10 includes a backup server 12, a management server 14, an Internet connection 40, an image forming apparatus 20, and a controller 70.

The backup server 12 saves image data, color profiles, and other information relevant to image formation to be shared within the image forming system 10. The backup server 12 is an example of a server. Also, color profiles are an example of first color adjustment data, second color adjustment data, and third color adjustment data. In the present exemplary embodiment, the third color adjustment data is a color profile saved in the backup server 12. Also, the second color adjustment data is a color profile, from among the third color adjustment data, to be used when an image forming apparatus 20B re-forms an image that was created by the image forming apparatus 20B in the past. In addition, the first color adjustment data is a color profile to be used when the image forming apparatus 20B re-forms an image that was created by an image forming apparatus 20A in the past.

The management server 14 selects any one image forming apparatus that is to form an image related to the image data.

The Internet connection 40 is a wired or wireless connection enabling bidirectional communication between components within the image forming system 10.

### Image Forming Apparatus

The image forming apparatus 20 is an apparatus that form an image onto a recording medium not illustrated. For example, an electrophotographic image forming apparatus that uses toner to form an image onto a recording medium is used as the image forming apparatus 20. Note that the image forming apparatus 20 may also be an inkjet image forming apparatus, and any of various types of image forming apparatuses are also usable. In an inkjet image forming apparatus, for example, an image is formed onto a recording medium by ejecting ink droplets onto the recording medium from an ejection unit not illustrated.

The image forming apparatus 20 performs steps such as charging, exposing, developing, and transferring and fusing onto a recording medium, for example. Also, multiple image forming apparatuses 20 are disposed in the image forming system 10. In the present exemplary embodiment, the image forming apparatus 20 is distinguished as three image forming apparatuses 20A, 20B, and 20C.

### Inspection Unit

The image forming apparatus 20 further includes an inspection unit 30, as illustrated in FIG. 1. The inspection unit 30 reads an image formed onto a recording medium and inspects the quality of the image on the basis of read data. The inspection unit 30 is disposed in each of the image forming apparatuses 20A, 20B, and 20C. The inspection by the inspection unit 30 is described later.

### Controller

As illustrated in FIG. 1, the controller 70 is connected to the backup server 12, the management server 14, and the image forming apparatus 20 via the Internet connection 40. The controller 70 instructs the image forming apparatus 20 to form an image on the basis of an instruction from the management server 14, and also acquires information saved in the backup server 12 and instructs the image forming apparatus 20 to re-form an image.

Multiple controllers 70 are disposed in the image forming system 10. In the present exemplary embodiment, the controller 70 are distinguished as three controllers 70A, 70B, and 70C, in correspondence with the image forming apparatuses 20A, 20B, and 20C, respectively. The controllers 70A, 70B, and 70C are independent of each other, and give instructions only to the corresponding image forming apparatuses 20A, 20B, and 20C.

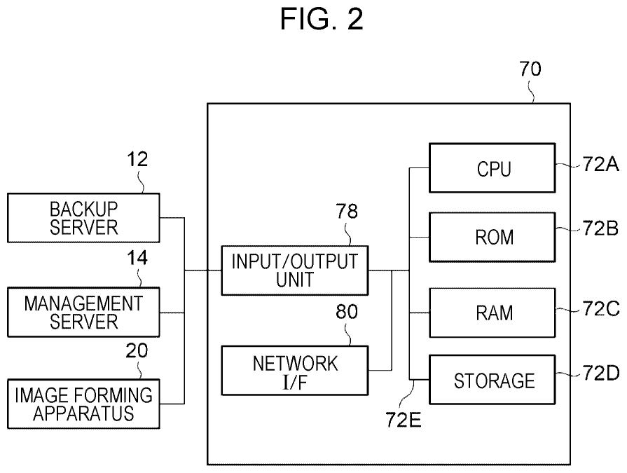

As illustrated in FIG. 2, the controller 70 includes the following components: a central processing unit (CPU) 72A, read-only memory (ROM) 72B, random access memory (RAM) 72C, storage 72D, an input/output unit 78, and a network interface (network I/F) 80. These components are communicatively interconnected through a bus 72E. The controller 70 is an example of an information processing system.

The CPU 72A is a central processing unit that executes various programs and controls each unit. In other words, the CPU 72A reads out a program from the ROM 72B or the storage 72D, and executes the program while using the RAM 72C as a work area. The CPU 72A is an example of a processor, and a control program executed by the CPU 72A is an example of an information processing program. The CPU 72A controls each of the above units and performs various types of arithmetic processing according to a program recorded in the ROM 72B or the storage.

The ROM 72B stores various programs and various data. The RAM 72C temporarily stores programs or data as a work area. The storage 72D includes a hard disk drive (HDD) or a solid-state drive (SSD), and stores various programs, including an operating system, as well as various data.

The input/output unit 78 receives signals between components of the image forming system 10 for exhibiting the functions of the image forming system 10. Specifically, the input/output unit 78 receives input from, and provides output to, the backup server 12, the management server 14, and the image forming apparatus 20, on the basis of instructions from a user not illustrated.

The network I/F 80 is an interface for communicating with other equipment such as a database or server not illustrated, and implements a standard such as Ethernet®, FDDI, or Wi-Fi®, for example.

### Summary of Image Forming System

As above, the image forming system 10 uploads image data and a color profile (third color adjustment data) to the backup server 12 with one of the image forming apparatuses 20A, 20B, or 20C selected from the management server 14 via the controller 70.

Next, details of image formation and re-formation by the image forming system 10 will be described. Note that in the following description, the controller 70 is described as being the controller 70B. Additionally, the controller 70B is an example of another image forming apparatus.

### Flow From Acceptance of Job to End of Job

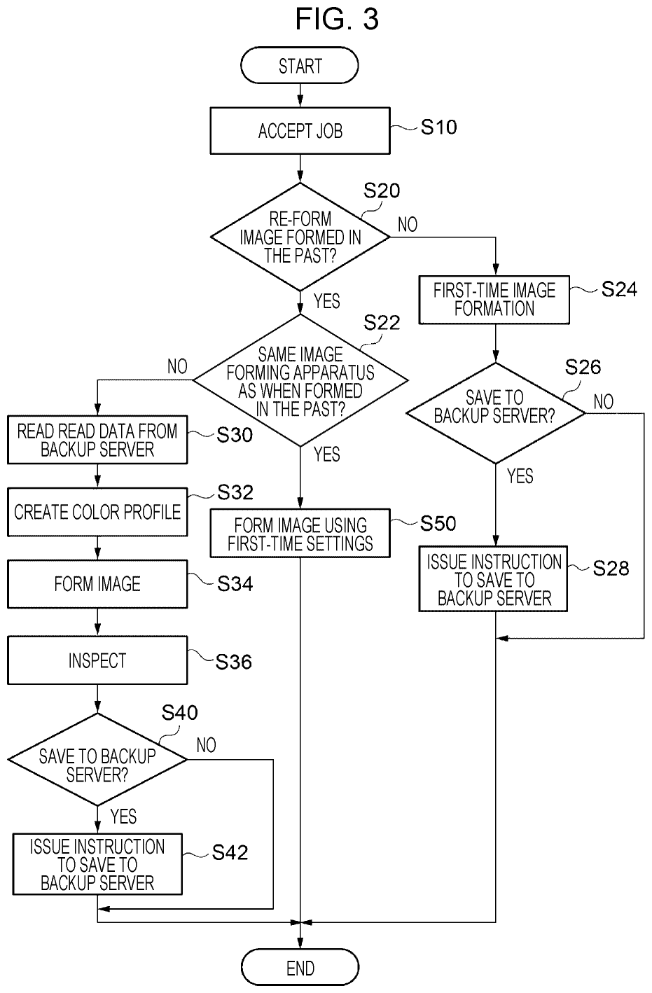

As illustrated in FIG. 3, in step S10, the CPU 72A of the controller 70B accepts image data (a document) relating to an image to be formed by the image forming apparatus 20B as a job. The CPU 72A then proceeds to step S20.

### First-time Image Formation

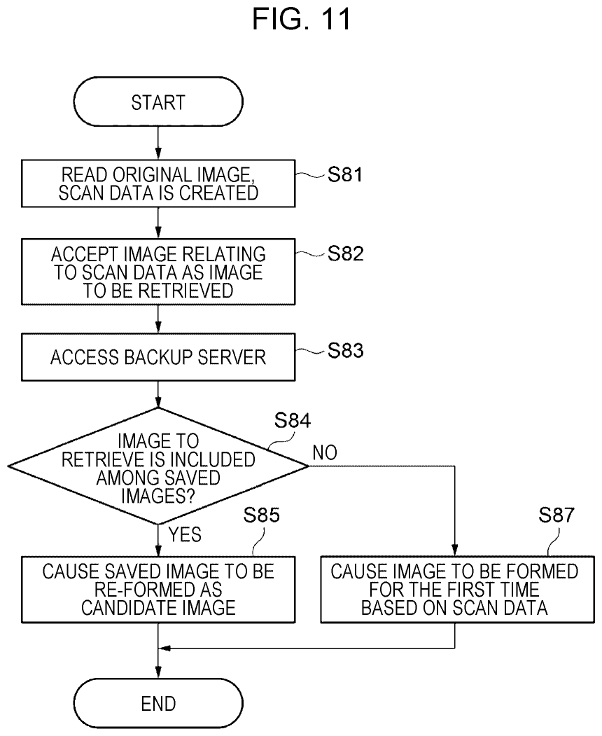

In step S20, the CPU 72A determines whether the image to be formed is the re-formation of an image that was formed in the past by any one of the image forming apparatuses 20. A detailed example of this determination will be described later using FIG. 11.

If the determination result is “NO” indicating negation, the image to be formed is deemed to be a new image formation, and the CPU 72A proceeds to step S24. Note that in this specification, the formation of a new image is referred to as first-time image formation.

On the other hand, if the determination result in step S20 is “YES” indicating affirmation, the image to be formed is deemed to be a re-formation, and the CPU 72A proceeds to step S22.

Upon proceeding to step S24, the CPU 72A instructs the image forming apparatus 20B to form an image. The CPU 72A then proceeds to step S26.

### Backup of First-time Image

In step S26, the CPU 72A determines whether to save, in the backup server 12, information pertaining to the image data relating to the formed image. If the determination result is “NO”, the CPU 72A proceeds to END without instructing the backup server 12 to save the information, and ends the job.

On the other hand, if the determination result in step S26 is “YES”, the CPU 72A proceeds to step S28 and instructs the backup server 12 to save the information. Note that in the case of saving, the CPU 72A causes the inspection unit 30A to read the image formed in advance by the image forming apparatus 20B, and saves the read image B and a new color profile (third color adjustment data). The CPU 72A then proceeds to END. Note that the read image B is an example of second read data.

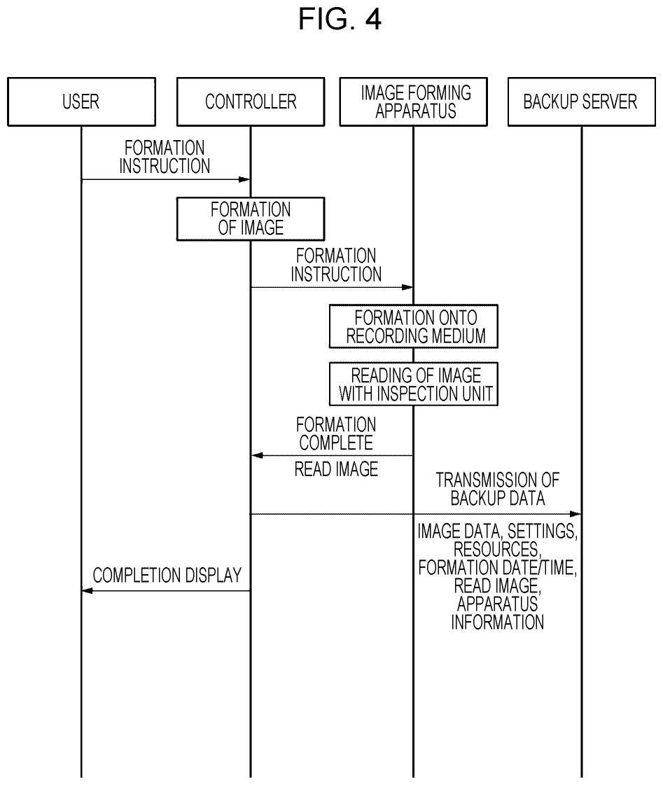

The sequence leading to END via steps S24, S26, and S28 will be described while referring to FIG. 4.

After the user gives an instruction to form an image, the controller 70B instructs the image forming apparatus 20B to form an image.

After the image forming apparatus 20B forms an image onto a recording medium, the inspection unit 30B reads the image and creates the read image B. The image forming apparatus 20B then transmits the read image B read by the inspection unit 30B, a formation complete notification, and other information to the controller 70B.

As described above, the controller 70B instructs the backup server 12 to save the information. Specifically, the controller 70B transmits, as backup data to the backup server 12, image data, the settings of the image forming apparatus 20B, resources which are parameters related to color adjustment and which include a color profile, the formation date and time when the image was formed, the read image B by the inspection unit 30B, and other information. The controller 70B also displays an indication of completion to the user.

According to the above, first-time image formation is performed by the image forming apparatus 20B, and the formed image is saved by the backup server 12.

### Re-formation of Image

Next, the case in which the CPU 72A proceeds to step S22 will be described using FIG. 3.

In step S22, the CPU 72A determines for the image to be re-formed which one of the image forming apparatuses 20 is the same image forming apparatus as when the image was formed in the past. In the present exemplary embodiment, the controller 70B determines whether the image was formed by the host apparatus, that is, the image forming apparatus 20B. Note that the first time is included in the past.

### Case of Same Apparatus

If the determination result is “YES”, the image to be re-formed and the image that was formed in the past are deemed to be by the host apparatus, that is, the image forming apparatus 20B, and the CPU 72A proceeds to step S50.

In step S50, the CPU 72A instructs the host apparatus, that is, the image forming apparatus 20B to form an image using the settings at the time of the past formation of the image, or in other words, the past color profile (second color adjustment data) at the time of the first-time image formation. Note that the past color profile may be data saved in a memory of the host apparatus, or may be read from the backup server 12. The CPU 72A then proceeds to END and ends the job.

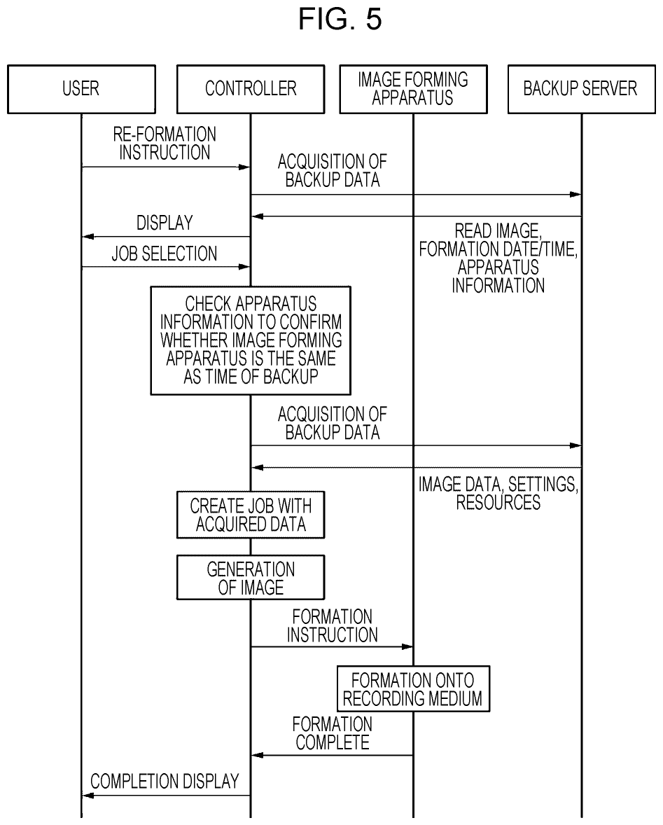

The sequence leading to END via steps S22 and S50 will be described while referring to FIG. 5.

First, the user gives an instruction to re-form an image.

Next, the controller 70B acquires, as backup data from the backup server 12, the read image B by the inspection unit 30B, the date and time when the image was formed, and apparatus information such as the model and serial code of the image forming apparatus 20B. The controller 70B then displays the content of the acquired backup data to the user and prompts the user to select an image as the job. Furthermore, the apparatus information included in the acquired backup data is checked to confirm that the image forming apparatus 20 at the time when the backup data was created is the host apparatus (image forming apparatus 20B).

The controller 70B further acquires, as backup data from the backup server 12, image data, the settings of the image forming apparatus 20B, resources (including a color profile as second color adjustment data), and other information.

The controller 70B then creates a job with the acquired backup data and instructs the image forming apparatus 20B to form an image.

After the image forming apparatus 20B forms an image onto a recording medium, the image forming apparatus 20B transmits a formation complete notification and other information to the controller 70B.

Lastly, the controller 70B displays an indication of completion to the user.

According to the above, an image is re-formed by the image forming apparatus 20B.

### Case of Other Apparatus

On the other hand, as illustrated in FIG. 3, when the determination result in step S22 is “NO”, the image is deemed to be re-formed by an image forming apparatus 20 different from the image forming apparatus 20 that formed the image in the past, and the CPU 72A proceeds to step S30. In the present exemplary embodiment, the CPU 72A of the controller 70B causes the host apparatus (image forming apparatus 20B) to re-form the image that was formed in the past (an example of a first image) by the image forming apparatus 20A different from the host apparatus (image forming apparatus 20B). In other words, the controller 70B is described as instructing the image forming apparatus 20B to re-form the image. Note that the image forming apparatus 20A is an example of a certain image forming apparatus.

In step S30, the CPU 72A acquires from the backup server 12 a read image A that was read by the inspection unit 30A of the image forming apparatus 20A. The read image A is an example of first read data. The CPU 72A then proceeds to step S32.

Next, in step S32, the CPU 72A creates a color profile (first color adjustment data) for the image forming apparatus 20B on the basis of the acquired read image A. The CPU 72A then proceeds to step S34.

Next, in step S34, the CPU 72A causes the image forming apparatus 20B to re-form an image on the basis of the color profile for the image forming apparatus 20B.

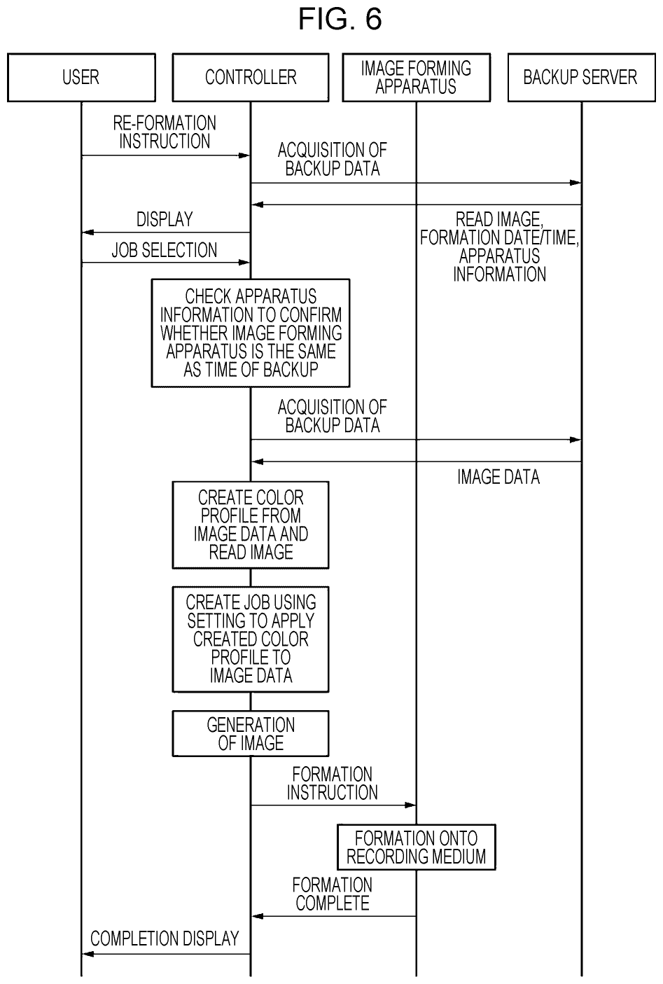

The sequence leading to step S34 via steps S30 and S32 will be described while referring to FIG. 6.

First, the user gives an instruction to re-form an image.

Next, the controller 70B acquires, as backup data from the backup server 12, the read image A by the inspection unit 30A of the image forming apparatus 20A, the date and time when the image was formed, and apparatus information. The controller 70B then displays the content of the acquired backup data to the user and prompts the user to select an image as the job. Furthermore, the apparatus information included in the acquired backup data is checked to confirm that the image forming apparatus 20 at the time when the backup data was created is the image forming apparatus 20A different from the host apparatus (image forming apparatus 20B).

The controller 70B further acquires at least image data as backup data from the backup server 12.

The controller 70B also creates a color profile for the image forming apparatus 20B from the acquired read image A by the image forming apparatus 20A and the image data.

The controller 70B creates a job in the image forming apparatus 20B using settings in which the created color profile for the image forming apparatus 20B is applied to the image data. The controller 70B then instructs the image forming apparatus 20B to form an image.

After the image forming apparatus 20B forms an image onto a recording medium, a formation complete notification and other information are transmitted to the controller 70B.

Lastly, the controller 70B displays an indication of completion to the user.

According to the above, an image is re-formed by the image forming apparatus 20B.

### Inspection

As illustrated in FIG. 3, when the image formation in step S34 is completed, the CPU 72A proceeds to S36.

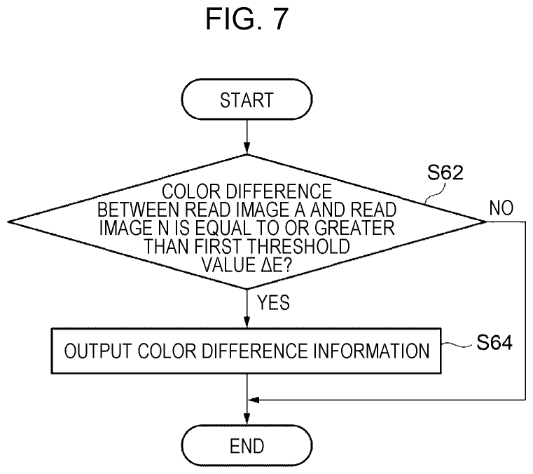

In step S36, the CPU 72A inspects the re-formed image with the inspection unit 30B of the image forming apparatus 20B. The details of inspection will be described using FIG. 7.

As illustrated in FIG. 7, the CPU 72A starts inspection. When inspection is started, the CPU 72A proceeds to step S62.

In step S62, the CPU 72A determines whether the color difference between the read image A by the image forming apparatus 20A in association with image formation in the past and a read image N by the image forming apparatus 20B in association with inspection is equal to or greater than a first threshold value ΔE. Note that the read image N is an example of third read data. Also, the first threshold value ΔE is a value set by the user to be at least one of the values obtained by converting each of the image data and the read image N to L*a*b*.

If the determination result is “YES”, the CPU 72A proceeds to step S64. In step S64, the CPU 72A outputs color difference information including the color difference. The CPU 72A then proceeds to END and ends the inspection.

On the other hand, if the determination result is “NO”, the CPU 72A proceeds to END and ends the inspection.

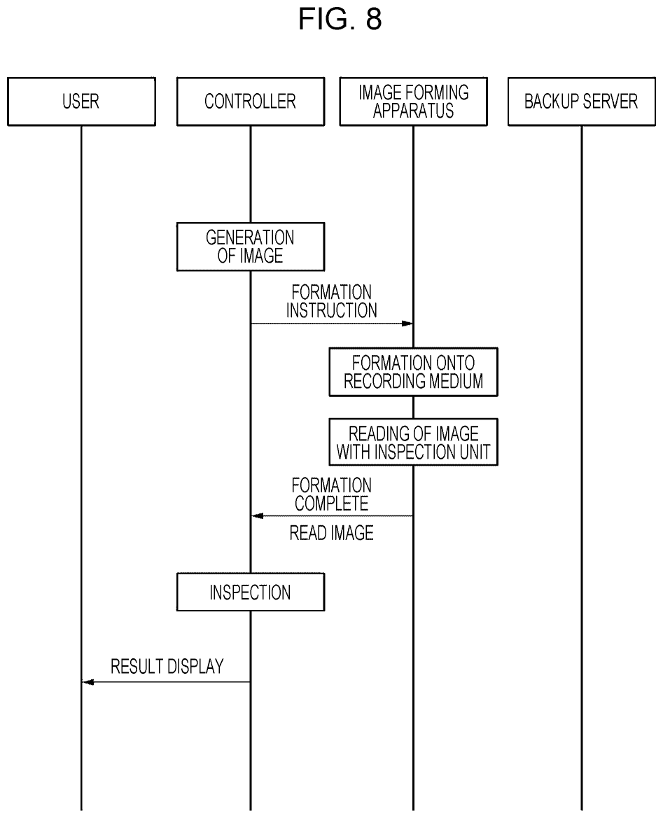

The sequence from step S34 to step S36 will be described while referring to FIG. 8.

First, the controller 70B instructs the image forming apparatus 20B to re-form an image.

Next, the image forming apparatus 20B re-forms an image onto a recording medium, and the re-formed image is read by the inspection unit 30B. The image forming apparatus 20B transmits a formation complete notification along with other information to the controller 70B.

Note that the controller 70B may also instruct the backup server 12 to save the read image N and the color profile (third color adjustment data) when the image was formed.

Additionally, the controller 70B displays an indication of completion to the user.

According to the above, an image is inspected by the controller 70B.

### Backup

As illustrated in FIG. 3, when the inspection in step S36 ends, the CPU 72A proceeds to S40.

In step S40, the CPU 72A determines whether to save, in the backup server 12, information pertaining to the image data relating to the re-formed image. If the determination result is “NO”, the CPU 72A proceeds to END without instructing the backup server 12 to save the information, and ends the job.

On the other hand, if the determination result in step S40 is “YES”, the CPU 72A proceeds to step S42 and instructs the backup server 12 to save the information. The CPU 72A then proceeds to END and ends the job.

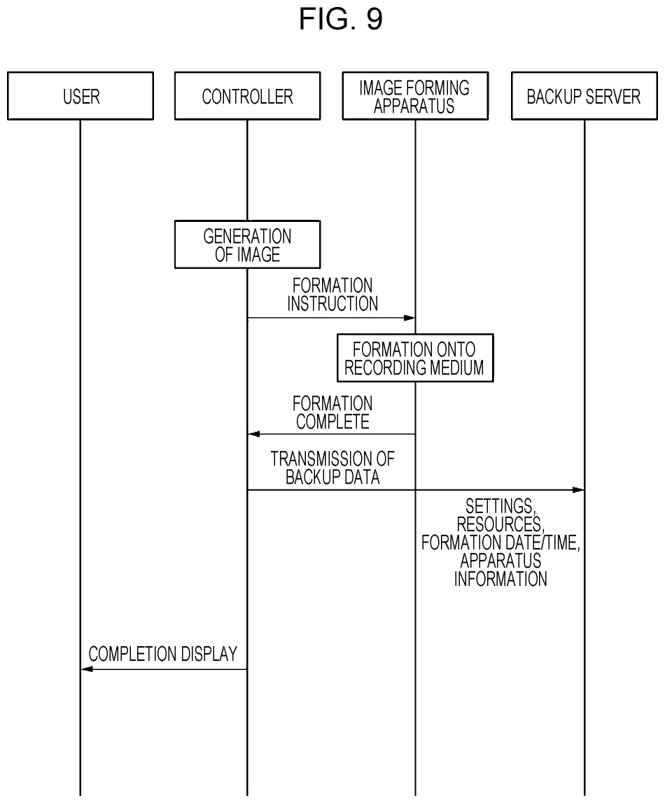

The sequence from step S40 to END will be described while referring to FIG. 9.

After the image forming apparatus 20B forms an image onto a recording medium, the image forming apparatus 20B transmits a formation complete notification and other information to the controller 70B.

The controller 70B instructs the backup server 12 to save the information. Specifically, the controller 70B transmits, as backup data to the backup server 12, settings and resources of the image forming apparatus 20B, the formation date and time when the image was re-formed, apparatus information, and the like. The controller 70B also displays an indication of completion to the user.

According to the above, an image with the color profile for the image forming apparatus 20B applied thereto is re-formed by the image forming apparatus 20B.

### Example of Image Retrieval

An example of image retrieval in the present exemplary embodiment will be described. In the exemplary embodiment above, as illustrated in FIG. 3, in step S10, the CPU 72A of the controller 70B accepts image data relating to an image to be formed by the image forming apparatus 20 as a job, but a variety of methods for accepting a job may be adopted. For example, an image retrieval mode is selectable in the case where multiple images have been formed in advance by the multiple image forming apparatuses 20A, 20B, and 20C, and read images relating to the formed images are saved in the backup server 12.

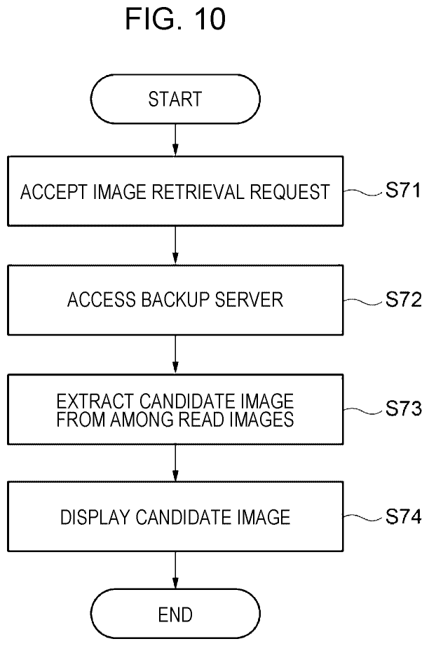

As illustrated in FIG. 10, the CPU 72A of the controller 70B starts the image retrieval mode. The CPU 72A then proceeds to step S71.

Next, in step S71, the CPU 72A accepts an image retrieval request. To accept the retrieval target, CPU 72A may access the backup server 12 in advance, display multiple saved images, and accept an image selected by the user as the retrieval target image. Upon accepting an image retrieval request, the CPU 72A proceeds to step S72.

Next, in step S72, the CPU 72A accesses the backup server 12. The CPU 72A then proceeds to step S73.

Next, in step S73, the CPU 72A extracts a candidate image to serve as a candidate for image formation from among the read data. The CPU 72A then proceeds to step S74.

Next, in step S74, the CPU 72A displays the candidate image to the user. In this case, the candidate image may be displayed along with information when the candidate image was formed, such as apparatus information and the formation date and time, for example. The CPU 72A then proceeds to END and ends retrieval.

### Example of Determining Re-formation

An example of determining image re-formation in the present exemplary embodiment will be described. In the exemplary embodiment above, as illustrated in FIG. 3, in step S20, the CPU 72A determines whether the image to be formed is the re-formation of an image that was formed in the past by any one of the image forming apparatuses 20, but a variety of methods for determining re-formation may be adopted. For example, the following method may be adopted in the case where the user possesses a recording medium with an image formed thereon and that image (original image) is to be re-formed.

As illustrated in FIG. 11, the CPU 72A starts an image re-formation determination mode. The CPU 72A then proceeds to step S81.

Next, in step S81, the CPU 72A reads the original image possessed by the user, and scan data is created. The scan data is an example of read data. The CPU 72A then proceeds to step S82.

In step S82, the CPU 72A accepts an image relating to the scan data as the retrieval target image. The CPU 72A then proceeds to step S83.

Next, in step S83, the CPU 72A accesses the backup server 12. The CPU 72A then proceeds to step S84.

Next, in step S84, the CPU 72A determines whether the retrieval target image is included among the images saved in the backup server 12.

If the determination result in step S84 is “NO”, the CPU 72A proceeds to step S87 and performs first-time image formation on the basis of the read data. Then CPU 72A then proceeds to END and ends the re-formation determination.

On the other hand, if the determination result in step S84 is “YES”, the CPU 72A proceeds to step S85 and performs re-formation using the image saved in the backup server 12 as the candidate image. Then CPU 72A then proceeds to END and ends the re-formation determination.

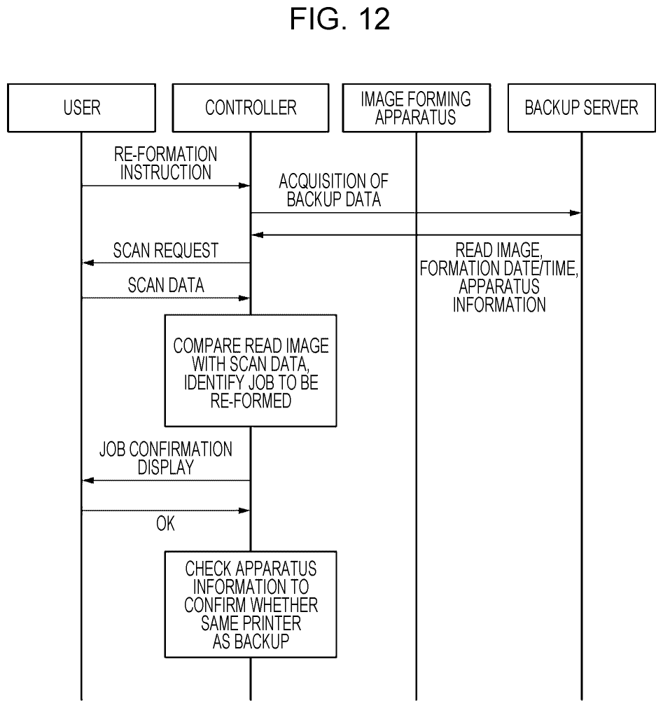

The sequence from step S80 to step S86 will be described using FIG. 12.

In response to a re-formation instruction from the user, the controller 70 acquires, as backup data from the backup server 12, the read image by the inspection unit 30 of the image forming apparatus 20, the date and time when the image was formed, and apparatus information.

Next, the controller 70B asks the user to scan the original image, and acquires scan data. The controller 70B compares the read data with the scan data and identifies the job as being a first-time image formation or a re-formation.

Lastly, the controller 70B displays a confirmation of the identified job to the user.

According to the above, the CPU 72A ends the re-formation determination mode.

### Operation

Next, the operation of the image forming system 10 according to the present exemplary embodiment will be described.

The controller 70B of the present exemplary embodiment executes, when instructed to form an image based on the same image data as an image that was formed by the image forming apparatus 20A, a mode to create a color profile for the image forming apparatus 20B on the basis of first read data obtained by reading the image that was formed by the image forming apparatus 20A, and cause the image forming apparatus 20B to form an image on the basis of the image data and the color profile for the image forming apparatus 20B. Also, a control program executed by the CPU 72A of the present exemplary embodiment causes a computer to execute a process including instructing a computer to execute, when instructed to form an image based on the same image data as an image that was formed by the image forming apparatus 20A, a mode to create a color profile for the image forming apparatus 20B on the basis of first read data obtained by reading the image that was formed by the image forming apparatus 20A, and cause the image forming apparatus 20B to form an image on the basis of the image data and the color profile for the image forming apparatus 20B.

Also, in a mode different from the mode, the controller 70B according to the present exemplary embodiment saves the read data B obtained by reading an image formed by the image forming apparatus 20B and a color profile by the image forming apparatus 20B when the image was formed, executes the mode upon being instructed to form an image based on the same image data as an image relating to saved read data, the read data being the first read data by the image forming apparatus 20A, and upon being instructed to form an image based on the same image data as an image relating to saved read data, the read data being the read data B by the image forming apparatus 20B, causes the image forming apparatus 20B to form an image on the basis of the image data and the color profile by the image forming apparatus 20B.

Also, the controller 70B according to the present exemplary embodiment saves third read data obtained by reading the image that the image forming apparatus 20B was made to form by executing the mode, and the color profile by the image forming apparatus 20B when the image was formed.

Also, the controller 70B according to the present exemplary embodiment acquires third read data obtained by reading the image that the image forming apparatus 20B was made to form by executing the mode, and outputs color difference information if a color difference between the first read data by the image forming apparatus 20A and the third read data by the image forming apparatus 20B is equal to or greater than a first threshold value.

Also, the controller 70 according to the present exemplary embodiment, upon accepting an image retrieval request, accesses the backup server 12 in which is saved read data of images formed by the multiple image forming apparatuses 20, and extracts and displays a candidate image.

Also, the controller 70 according to the present exemplary embodiment accesses the backup server 12 in which is saved read data of images formed by the multiple image forming apparatuses 20, displays multiple saved images, and accepts an image selected by the user as a retrieval target image.

Also, the controller 70 according to the present exemplary embodiment accepts an image relating to scan data created by reading an original image as a retrieval target image, accesses the backup server 12 in which is saved read data of images formed by the multiple image forming apparatuses 20, and extracts the candidate image from a comparison of the retrieval target image and the saved images.

Additionally, the controller 70 according to the present exemplary embodiment, upon accepting an instruction to form the same image as the original image in a case in which the saved images do not match the retrieval target image, causes an image forming apparatus to form an image on the basis of the scan data of the retrieval target.

### Exemplary Modifications

The foregoing describes exemplary embodiments of the present disclosure with reference to the drawings, but it is clear that a person having ordinary knowledge in the field of technology to which the present disclosure belongs could conceive of various exemplary modifications or exemplary applications within the scope of the technical ideas set forth in the claims, and it is understood that these exemplary modifications or exemplary applications also naturally fall within the technical scope of the present disclosure.

The above processing may also be achieved by a dedicated hardware circuit. In this case, the processing may be executed by a single piece of hardware or by multiple pieces of hardware.

In the exemplary embodiments above, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. Alternatively, multiple operations performed by a specific plurality of processors in the exemplary embodiments above may be partially or wholly combined and performed by a single processor. The order of operations of the processor is not limited to one described in the exemplary embodiment above, and may be changed.

Also, a program that causes the controller 70 to operate may be provided by a non-transitory computer-readable recording medium such as Universal Serial Bus (USB) memory, a flexible disk, or a Compact Disc-Read-Only Memory (CD-ROM) disc, and may also be provided online over a network such as the Internet. In this case, the program recorded onto the non-transitory computer-readable recording medium is normally transferred and stored in memory, storage, or the like. Additionally, for example, the program may be provided as standalone application software, or the program may be incorporated into the software of each device as a function of the controller 70.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

1

An information processing system comprising:
a processor configured to:
upon being instructed to form an image based on the same image data as a first image that was formed by a certain image forming apparatus,
execute a mode to create first color adjustment data for another image forming apparatus on the basis of first read data obtained by reading the first image that was formed by the certain image forming apparatus, and cause the other image forming apparatus to form an image on the basis of the image data and the first color adjustment data.
2

The information processing system according to 1, wherein
the processor is configured to:
in a mode different from the mode, save second read data obtained by reading an image formed by the other image forming apparatus and second color adjustment data when the image was formed;
execute the mode upon being instructed to form an image based on the same image data as an image relating to saved read data, the read data being the first read data; and
upon being instructed to form an image based on the same image data as an image relating to saved read data, the read data being the second read data, cause the other image forming apparatus to form an image on the basis of the image data and the second color adjustment data.
3

The information processing system according to 2, wherein
the processor is configured to:
save third read data obtained by reading the image that the other image forming apparatus was made to form by executing the mode, and third color adjustment data when the image was formed.
4

The information processing system according to any one of 1 to 3, wherein
the processor is configured to:
acquire third read data obtained by reading the image that the other image forming apparatus was made to form by executing the mode; and
output color difference information if a color difference between the first read data and the third read data is equal to or greater than a first threshold value.
5

The information processing system according to any one of 1 to 4, wherein
the processor is configured to:
upon accepting an image retrieval request, access a server in which is saved read data of images formed by a plurality of image forming apparatuses, and extract and display a candidate image.
6

The information processing system according to 5, wherein
the processor is configured to:
access a server in which is saved read data of images formed by a plurality of image forming apparatuses, display a plurality of saved images, and accept an image selected by a user as a retrieval target image.
7

The information processing system according to 5, wherein
the processor is configured to:
accept an image relating to read data created by reading an original image as a retrieval target image; and
access a server in which is saved read data of images formed by a plurality of image forming apparatuses, and extract the candidate image from a comparison of the retrieval target image and the saved images.
8

The information processing system according to 7, wherein
the processor is configured to:
upon accepting an instruction to form the same image as the original image in a case in which the saved images do not match the retrieval target image,
cause an image forming apparatus to form an image on the basis of the read data of the retrieval target.
9

An information processing program causing a computer to execute a process comprising:
upon being instructed to form an image based on the same image data as a first image that was formed by a certain image forming apparatus,
instructing the computer to execute a mode to create first color adjustment data for another image forming apparatus on the basis of first read data obtained by reading the first image that was formed by the certain image forming apparatus, and cause the other image forming apparatus to form an image on the basis of the image data and the first color adjustment data.

What is claimed is:

1. An information processing system comprising:
a processor configured to:
upon being instructed to form an image based on the same image data as a first image that was formed by a certain image forming apparatus, execute a mode to create first color adjustment data for another image forming apparatus on the basis of first read data obtained by reading the first image that was formed by the certain image forming apparatus, and cause the other image forming apparatus to form an image on the basis of the image data and the first color adjustment data.

2. The information processing system according to claim 1, wherein the processor is configured to:
in a mode different from the mode, save second read data obtained by reading an image formed by the other image forming apparatus and second color adjustment data when the image was formed;
execute the mode upon being instructed to form an image based on the same image data as an image relating to saved read data, the read data being the first read data; and
upon being instructed to form an image based on the same image data as an image relating to saved read data, the read data being the second read data, cause the other image forming apparatus to form an image on the basis of the image data and the second color adjustment data.

3. The information processing system according to claim 2, wherein the processor is configured to save third read data obtained by reading the image that the other image forming apparatus was made to form by executing the mode, and third color adjustment data when the image was formed.

4. The information processing system according to claim 1, wherein the processor is configured to:
acquire third read data obtained by reading the image that the other image forming apparatus was made to form by executing the mode; and
output color difference information if a color difference between the first read data and the third read data is equal to or greater than a first threshold value.

5. The information processing system according to claim 1, wherein the processor is configured to, upon accepting an image retrieval request, access a server in which is saved read data of images formed by a plurality of image forming apparatuses, and extract and display a candidate image.

6. The information processing system according to claim 5, wherein the processor is configured to access a server in which is saved read data of images formed by a plurality of image forming apparatuses, display a plurality of saved images, and accept an image selected by a user as a retrieval target image.

7. The information processing system according to claim 5, wherein the processor is configured to:
accept an image relating to read data created by reading an original image as a retrieval target image; and
access a server in which is saved read data of images formed by a plurality of image forming apparatuses, and extract the candidate image from a comparison of the retrieval target image and the saved images.

8. The information processing system according to claim 7, wherein the processor is configured to, upon accepting an instruction to form the same image as the original image in a case in which the saved images do not match the retrieval target image, cause an image forming apparatus to form an image on the basis of the read data of the retrieval target.

9. An information processing method comprising:
upon being instructed to form an image based on the same image data as a first image that was formed by a certain image forming apparatus, executing a mode to create first color adjustment data for another image forming apparatus on the basis of first read data obtained by reading the first image that was formed by the certain image forming apparatus, and cause the other image forming apparatus to form an image on the basis of the image data and the first color adjustment data.

10. A non-transitory computer readable medium storing a program causing a computer to execute a process comprising:
upon being instructed to form an image based on the same image data as a first image that was formed by a certain image forming apparatus, instructing the computer to execute a mode to create first color adjustment data for another image forming apparatus on the basis of first read data obtained by reading the first image that was formed by the certain image forming apparatus, and cause the other image forming apparatus to form an image on the basis of the image data and the first color adjustment data.
